(19) United States
(12) Patent Application Publication
(10) Pub. No.: US 2004/0247635 A1
(43) Pub. Date: Dec. 9, 2004

(54) Insect repelling resin system and insect repelling method using the same

(76) Inventors: Osamu Igarashi, Yokohama-shi (JP); Noriyoshi Komiyama, Sagamihara-shi (JP)

Correspondence Address: CARR & FERRELL LLP, 2200 GENG ROAD, PALO ALTO, CA, 94303, US

(21) Appl. No.: 10/693,079

(22) Filed: Oct. 23, 2003

(30) Foreign Application Priority Data
Jun. 3, 2003 (JP) 2003-158574

(51) Int. Cl. A01N 25/00

(52) U.S. Cl. 424/405

(57) ABSTRACT

The present invention provides an insect repelling resin product comprising an insect repelling component which is gradually discharged over a long period of time. The insect repelling resin product is manufactured into a geometric feature applicable for use in various environments to prevent or deter penetration of an object by insects. The geometric feature comprise a main body, a main body having a hollow center, an elongated U-shaped body having an opening end portion forming a groove and in some embodiments, a plurality of slits, a spiral shape, a tube shape with a longitudinal slit, a C-shaped curvature portion coupled to a male and female engagement portion, or an elastic strip further comprising locking portion and an engagement portion.

### CROSS-REFERENCE TO RELATED APPLICATIONS

This application claims the priority and benefit of Japanese Patent Application Serial No. 2003-158574 entitled “Insect Repelling Resin Product and Insect Repelling Method Using Same,” filed on Jun. 3, 2003, which is herein incorporated by reference.

### BACKGROUND OF THE INVENTION

1. Field of the Invention

The present invention relates to an insect repelling products and more particularly to an insect repelling resin product for securing apparatuses from damage caused by insects.

2. Description of Related Art

Conventionally, many insect repelling resin products are designed for agricultural use. In some embodiments, the products may utilize a flared skirt-shaped resin product containing an arthropod repellant. This product contains an element having a repelling effect against insects. When this product is mounted on stems of plants bearing fruits, nuts, flowers, etc., the additive effect of the skirt shape and the repellent prohibits or deters harmful insect, in particular fire ants or red imported fire ants (“RIFA”), that climb from the ground up the stem from surpassing the product and reaching the fruit, nuts, flowers, etc. on the stem. Thus, damage to agricultural products can be prevented thereby.

However, damage caused by insects is not limited to agricultural products, but extends to apparatuses, houses, vehicles, etc. that require hermetical sealability. For example, insects such as ants penetrate apparatuses that are installed outdoors (e.g., traffic signal controllers) or apparatuses used outdoors (e.g., automobiles, motorcycles, tractors). Further, there have been numerous reports of such insects building nests therein in southern parts of the United States.

One would not normally expect insects to gather in outdoor apparatuses such as traffic signal controllers since there is no food inside. However, wind and rain does not affect an inside of these outdoor apparatuses and a constant temperature is maintained within these apparatuses even during winter seasons. Further, the insects may use the apparatus to shelter themselves from foreign enemies. Thus, the outdoor apparatus likely provides a comfortable and safe environment for the insects.

Disadvantageously, penetration of the insects into the outdoor apparatuses may cause malfunctions in the outdoor apparatuses. Typically, insects such as ants or similar insects with small body sizes are able to penetrate into the outdoor apparatus even from a small gap. Once inside the outdoor apparatus, the insects may penetrate a control circuit via wiring. Often time, most of the insects die within the outdoor apparatus since the insects are not able to exit the outdoor apparatus. Consequently, a hormone-lie substance is discharged from the dead insect, and this substance becomes a factor in attracting further insects. The attracted insects similarly penetrate into the control circuit via the small gap and wiring of the outdoor apparatus. Insects that are not able to exit from the outdoor apparatus will continue to die within the outdoor apparatus. As this process repeats, the control circuit may eventually short circuit or become insulted and results in the malfunction of the outdoor apparatus. Estimates of a total amount of damage caused thereby is said to be eight to one hundred twenty billion Japanese yen annually.

A conventional method of repelling insects comprises spraying a liquid insect repellent or placing a solid insect repellant in or around the apparatus. However, these methods typically only have an effect of several days to several weeks. Further, these methods are not suitable for an apparatus, such as a traffic signal controller, used for an extended period of time (e.g., five to tens years) since a long-term insect repellant effect is required. It would be time consuming and non-economical to perform these conventional methods every few weeks. Additionally, spraying liquid insect repellent may cause damage to sensitive outdoor apparatuses.

Alternatively, the penetration of insects may be prevented in prior art systems by employing a device to heat the insect repellent, such as with a heater. The heating process will gradually discharge the insect repellant over time. However, since space is required for installing the heating device inside the apparatus, there are limitations for using such a method in existing apparatuses (i.e., the apparatuses are not designed with enough space for the heating device). Additionally, this method would result in relatively expensive installation costs.

Furthermore, the insects not only cause damage to agricultural products and outdoor apparatuses, but the insects are known to cause damage to human beings. For example, when a fire ant bites a human being, a bite area may swell in a manner similar to a fire burn causing severe pain and itchiness. Additionally, numerous other poisonous insects exist. For example, some arthropods such as spiders, centipedes, and some creatures referred to as harmful insects (e.g., mosquitoes, flies, cockroaches, termites, ticks, fleas, and nematode worms) are poisonous. Thus, some type of measure needs to be taken to prevent these insects from penetrating into apparatuses such as automobiles, motorcycles, and tractors that are operated by human being and often parked outside, as well as houses, apartments, condominiums, buildings, hotels, and other structures.

Therefore, there is a need for an insect repelling system capable of preventing the penetration of the insects into an object to be protected from the insects. Because, many apparatuses often have a complex shape, in comparison to the tree stem, there is a further need for the insect repelling system to be capable of protecting an object having such a complex shape from damage caused by the insects. Furthermore, there is a need for an insect repelling method for preventing the penetration of the insects into an object to be protected from the insects.

### SUMMARY OF THE INVENTION

The present invention provides a system and method for producing and utilizing an insect repelling resin product comprising an insect repelling component which is gradually discharged over a long period of time. The insect repelling resin product is manufactured into a geometric feature applicable for use in various environments to prevent or deter penetration of an object by insects. The geometric feature comprise a main body, a main body having a hollow center, an elongated U-shaped body having an opening end portion forming a groove and in some embodiments, a plurality of slits, a spiral shape, a tube shape with a longitudinal slit, a C-shaped curvature portion coupled to a male and female engagement portion, or an elastic strip further comprising locking portion and an engagement portion. Other geometric features are contemplated.

Based on the geometric feature of the insect repelling resin product, penetration of the insects into an object or apparatus can be prevented or deterred merely by installation of the insect repelling rein product. In some embodiments, this is accomplished by the insect repelling rein product covering the aperture, partition, or edge portion thus physically blocking the insects from penetrating. Further, the insect repelling resin product is capable of elastic deformation in conformity with an aperture, partition, or edge portion of the object for ease or installation and to reduce or eliminate gaps through which insects may penetrate. In some embodiments, the insect repelling resin product comprises slits which allow employment of the insect repelling resin product along curvatures. Yet further embodiments having a spiral or tubular shape may be utilized about one or more long bodies. When more than one long body is disposed within the insect repelling resin product, the insect repelling resin product essentially bundles the long bodies together.

Further, the shape, size, and longevity of the insect repelling resin product allows for economical implementation of the insect repelling resin product in pre-existing or small objects. Because the insect repelling component is gradually discharged over a long period of time (e.g., 5-10 years), the present invention may be utilized in many objects having long life-spans such as a relay box, buildings, or traffic signal controller. Additionally, the small size of the insect repelling resin product allows for the implementation of the product in pre-existing objects without having to redesign or modify these objects.

### BRIEF DESCRIPTION OF THE DRAWINGS

FIG. 1 is a perspective view of an exemplary insect repelling resin system, according to one embodiment of the present invention;

FIG. 2 is a perspective view of an exemplary insect repelling resin system, according to a second embodiment of the present invention;

FIG. 3 is a perspective view of an exemplary insect repelling resin system, according to a third embodiment of the present invention;

FIG. 4 is a perspective view of an exemplary insect repelling resin system, according to a fourth embodiment of the present invention;

FIG. 5 is a perspective view of an exemplary insect repelling resin system, according to a fifth embodiment of the present invention;

FIG. 6 is a perspective view of an exemplary insect repelling resin system, according to a sixth embodiment of the present invention;

FIG. 7 is a perspective view of an exemplary insect repelling resin system, according to a seventh embodiment of the present invention;

FIG. 8 is a perspective view of an exemplary insect repelling resin system, according to an eighth embodiment of the present invention;

FIG. 9A is a perspective view of an exemplary insect repelling resin system, according to a ninth embodiment of the present invention;

FIG. 9B is a front view of the exemplary insect repelling resin of FIG. 9A;

FIG. 10 is a perspective view of an exemplary insect repelling resin system, according to a tenth embodiment of the present invention;

FIG. 11 is a perspective view of an exemplary insect repelling resin system, according to an eleventh embodiment of the present invention;

FIG. 12 is an exemplary diagram showing a state of use of the insect repelling resin system of FIG. 10;

FIG. 13A is an example of an outdoor apparatus utilizing the present invention in a cover closed state;

FIG. 13B is the example of FIG. 13A in a cover open state;

FIG. 14A is a further example of an outdoor apparatus utilizing the present invention in a door closed state; and

FIG. 14B is the example of FIG. 14A in a door open state.

### DESCRIPTION OF THE EXEMPLARY EMBODIMENTS

The present invention provides a system and method for repelling insects. According to embodiments of the present invention, insect repelling components are contained within a resin. An insect repelling resin product or system comprises a geometric feature or shape applicable to an object to be protected. In some embodiments, a space is located at a partition (i.e., partitioning an inside and outside of the object) through which the insects penetrate into the object. By providing the insect repelling resin product at this partition and gradually discharging the insect repelling resin component, the penetration of the insects into the object is prevented. Thus, damage to the apparatus and human beings can also be prevented. Additionally, the insect repelling resin product of the present invention may be adjusted or adapted in order to be employed in existing apparatuses.

The insect repelling component of each insect repelling resin product may comprise a compound having an insect repelling effect, an insect killing effect, an anti-feeding effect, a growth-control effect, or any other effect detrimental to the insects. Specifically, the insect repelling component may comprise pyrethroid compounds, carbamate compounds, organic phosphorous compound and isomers, derivatives and affinities thereof, and other compounds having an effect of controlling growth of insects.

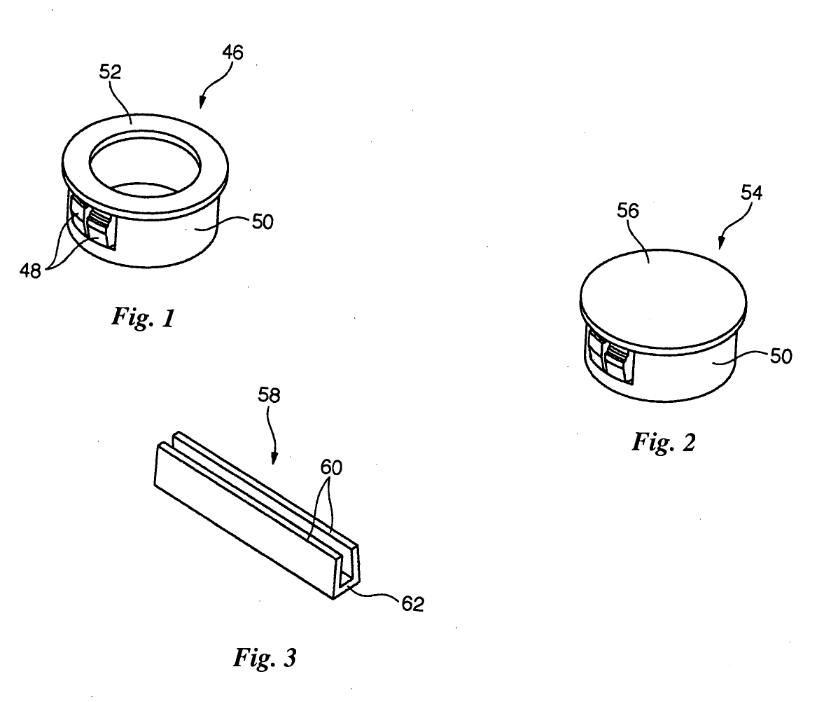

The insect repelling resin product must be structured into a shape applicable to an aperture that penetrates the partition of the object, and comprise a main body to be inserted into the aperture and means for fastening the main body to the partition. Referring to FIG. 1, an exemplary embodiment of an insect repelling resin product 46 is shown. The insect repelling resin product 46 comprises an approximately circular main body 50 with a hollow center and a flange 52 formed along a top side of the main body 50. Preferably, an outer diameter of the flange 52 protrudes wider than an outer diameter of the main body 50. Further, a hook-shaped protrusion 48 is provided at an outer peripheral face of the main body 50.

When the main body 50 of the insect repelling resin product 46 is inserted into an aperture penetrating a partition separating an inside portion of an object from an outside portion of the object, the protrusion 48 locks with an inside wall of the partition structuring the aperture. Since a thickness of the wall differs depending on the object, in order to be compatible therewith, the protrusion 48 has a locking part in which a left shape 48a and a right shape 48b are different. Thus, the inside wall may be locked with either the left shape 48a, the right shape 48b, or both.

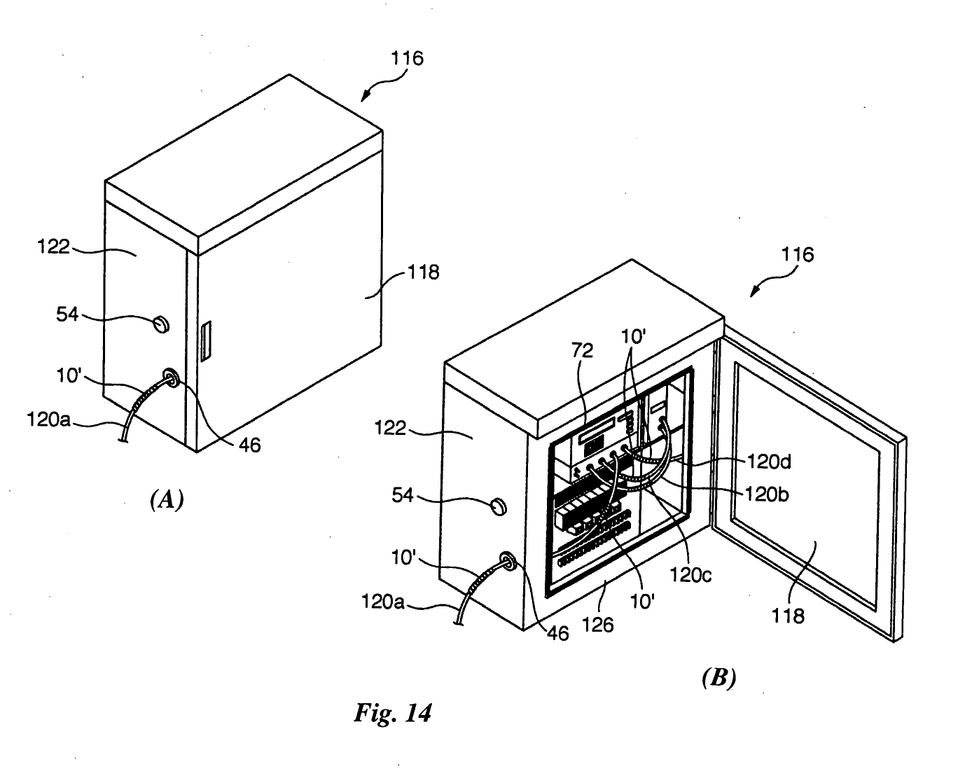

FIGS. 14A-B shows an example of usage of the insect repelling resin product 46 of FIG. 1. A relay box 116 is illustrated in a door closed state (FIG. 14A) and a door open state (FIG. 14B). In this example, a cord or wiring 120a is connected to the relay box 116 via an aperture formed in a wall 122. The insect repelling resin product 46 is fitted into this aperture for concurrently protecting the cord 120a from friction with the wall 122 and for deterring the insects from penetrating the relay box 116 via the aperture.

During installation of the insect repelling resin product 46 into the aperture, the main body 50 (FIG. 1) is deformed and inserted into the aperture, and the protrusion 48 (FIG. 1) coupled to the outer peripheral face of the resin repelling resin product 46 engages with an inside surface of the wall 122 (not shown). As a result of the flange 52 (FIG. 1) contacting an outer surface of the wall 122, the main body 50 is fastened to the wall around the aperture. This fastening occurs upon fitting the main body 50 into the aperture and sandwiching a part of the partition forming the aperture between the flange 52 and the protrusion 48 so as to make release of the main body 50 from the aperture difficult. The insect repelling resin product 46 thereby prevents insects such as ants from physically penetrating into the object via the apertures (i.e., by making the aperture smaller and by gradually releasing insect repelling components in the resin).

Referring now to FIG. 2, an exemplary embodiment of an alterative insect repelling resin product 54 is shown. The insect repelling resin product 54 of FIG. 2 differs from the embodiment of FIG. 1 by comprising a blocking cover 56 formed in lieu of the flange 52 of FIG. 1. This blocking cover 56, essentially, blocks insects from penetrating an aperture.

Referring back to FIG. 14A-B, an example of usage of the insect repelling resin product 54 of FIG. 2 is shown. In this example, the relay box 116 is provided with an auxiliary aperture on the wall 122 for inserting and passing a wire such as a cord through. When this aperture is not used or necessary, the aperture needs to be blocked so as to prevent penetration by insects into the relay box 116. As such, the insect repelling resin product 54 is fitted into the auxiliary aperture to prevent the insects from penetrating into the relay box 116 via the auxiliary hole. Additionally, the gradual discharging of the insect repelling component from the resin further prevents the penetration of the insects even when a minor gap arises between the insect repelling resin product 54 and the auxiliary hole.

FIG. 3 illustrates another embodiment of an insect repelling resin product 58, according to the present invention. The insect repelling resin product 58 has an approximate horseshoe-shape or U-shaped about its cross-section. The insect repelling resin product 58 is further provided with an opening end portion 60 in which an edge portion of an object may be inserted facing a groove portion structured from a bottom portion 62 thereof. When the opening end portion 60 is inserted into the edge portion of the object, the opening end portion 60 expands due to flexibility of the insect repelling resin product 58. Upon elastic deformation, the edge portion of the object will thereby be fitted into the groove portion.

Resultingly, the insect repelling product 58 will be exposed to a gap where the insects may penetrate, thus increasing sealability by blocking the gap. Furthermore, the insect repelling component will gradually discharge from the insect repelling resin product 58 and prevent the insects from gaining entrance into the apparatus via the gap. Additionally, by suitably adjusting an interval of the opening end portion 60, the fit of the repelling resin product 58 into the protruding portion of the apparatus can be adjusted.

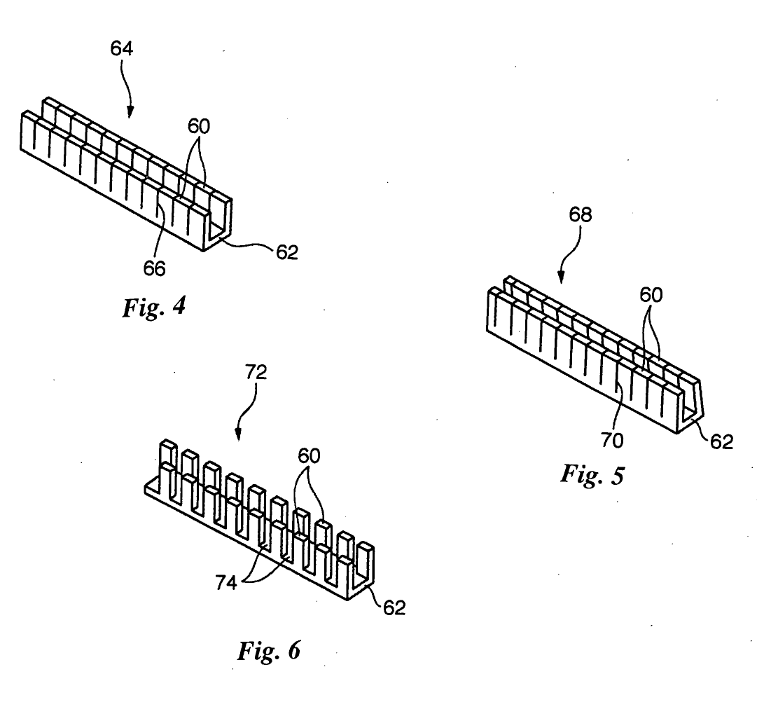

FIG. 4 is an alternative embodiment of an insect repelling resin product 64. The insect repelling resin product 64 is similar to the embodiment of FIG. 3. However, the insect repelling resin product 64 further comprises a plurality of slits 66 formed from the opening end portion 60 towards the bottom portion 62. The plurality of slits 66 allows the insect repelling resin product 64 to curve about an edge portion of an apparatus or object.

Referring now to FIG. 5, another embodiment of an insect repelling resin product 68 is shown. The embodiment of FIG. 5 differs from the FIG. 3 embodiment in that the insect repelling resin product 68 comprises a plurality of slits 70 formed from the opening end portion 60 to the bottom portion 62. Further, the embodiment of FIG. 5 differs from the FIG. 4 embodiment in that the opening end portion 60 is narrower than the bottom portion 62 which allows for a tighter fit into the protruding edge portion of the object or apparatus.

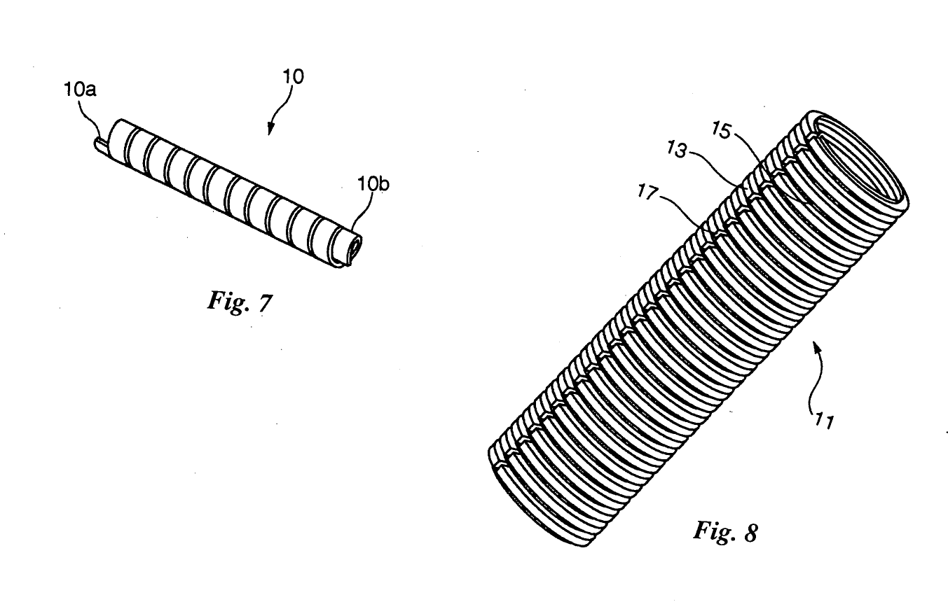

Referring now to FIG. 6, a further embodiment of an insect repelling resin product 72 is illustrated. The insect repelling resin product 72 comprises a plurality of slits 74 of a wider width than those of the FIG. 4 and FIG. 5 embodiments. Thereby, a degree of freedom of curvature will be increased over those of the FIG. 4 and FIG. 5 embodiments, and the insect repelling resin product 72 can be employed even in portions having acutely angled curvatures.

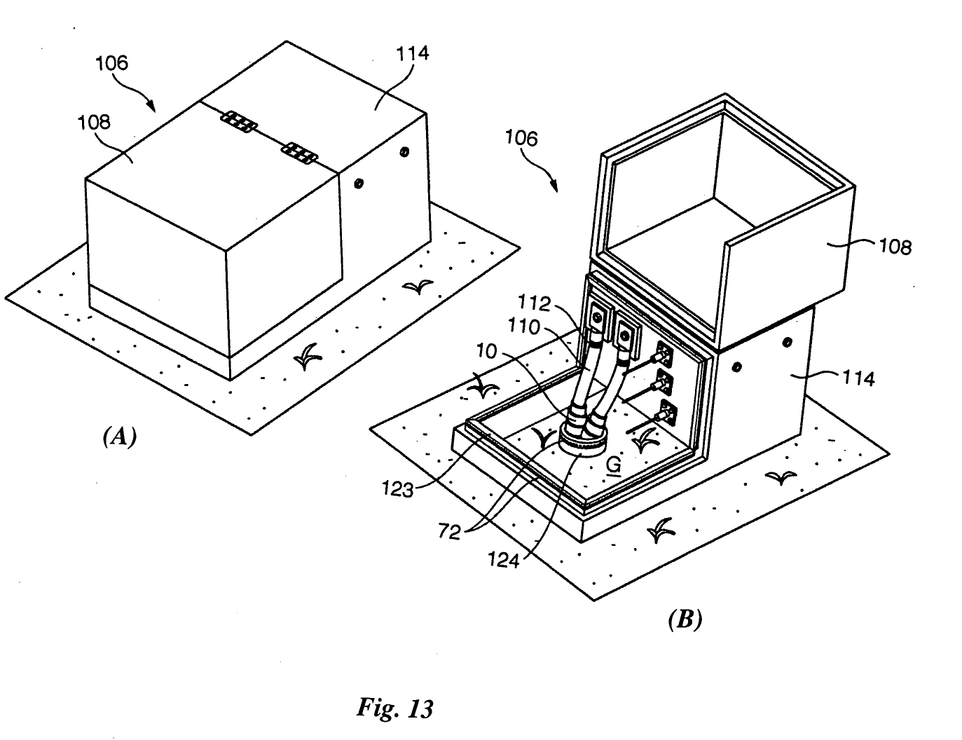

FIG. 13A through FIG. 14B illustrate examples employing the use of the insect repelling resin product 72 of FIG. 6. In the example of FIG. 13B, the insect repelling resin product 72 is fitted into a protruding edge portion 123 to which a cover 108 and a main body 114 of an object (i.e., traffic signal controller 106) contact. Because the protruding edge portion 123 is linear, the insect repelling resin product 72 is fitted in a linear fashion. Similarly, FIG. 14B illustrates the insect repelling resin product 72 fitted along a linear edge or protruding edge portion of an opening of the relay box 116. Furthermore, since the insect repelling resin product 72 has a high degree of freedom of curvature, the insect repelling resin product 72 may also be disposed along a curved protruding portion, such as around a ground gateway 124 of a cable 112 covered with a protective member 110 as shown in FIG. 13B. Although FIG. 13A through FIG. 14B utilizes the insect repelling resin product 72 of FIG. 6 along the linear protruding edge portions, alternatively, the insect repelling resin products 58, 64, and 68 may be employed. Additionally, the insect repelling resin products 64 and 68 may also be employed in curved protruding edge portions.

Referring now to FIG. 7, an insect repelling resin product 10 of another embodiment of the present invention is shown. This embodiment of the insect repelling resin product 10 comprises a spiral shape capable of elastic deformation and having a first and second end portion 10a and 10b, respectively. When the first end portion 10a is held stationary and the second end portion 10b is rotated in a clockwise direction, an elastic force converges toward a central axis direction of the insect repelling resin product 10 and an inside diameter of the insect repelling resin product 10 will contract. As a result of utilizing such property, a plurality of wiring may be bundled, or the insect repelling resin product 10 may be wound around a pillar-shaped member (i.e., long body). Thus, the insect repelling resin product 10 may be installed without having to employ a fastening means such as a screw.

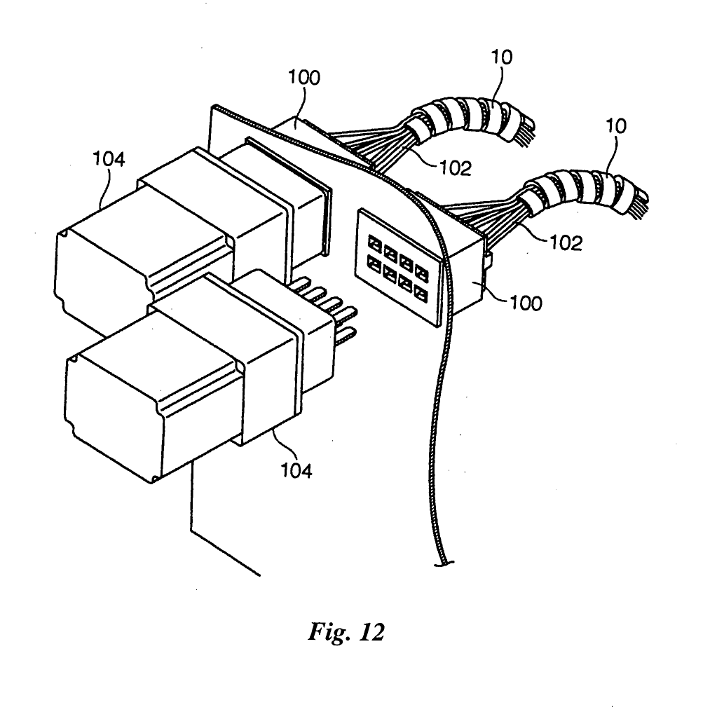

FIG. 12 illustrates an example of the insect repelling resin product 10 in use. As shown, the insect repelling resin product 10 is wound around and elastically installed about a plurality of wiring 102 connect to a connector 100 which internally possesses an electronic circuit. In addition to being able to gather together the plurality of wiring 102, by gradually discharging the insect repelling component from the insect repelling resin product 10, a control unit 104 may be protected from insects penetrating into the apparatus via the plurality of wiring 102. Because the insect repelling resin product 10 is able to prevent or deter the insects trying to enter via the plurality of wiring 102, the control component 104 is protected from failure or malfunction (i.e., short circuit or break) caused by insect penetration.

As a further example of use of the insect repelling resin product 10, FIG. 13B illustrates the insect repelling resin product 10 employed around a pillar-shaped member. Normally, although a cable 112 is protected with a cylindrical protective member 110, there is a possibility that insects may enter through the underground protective member 110 and penetrate inside the apparatus (e.g., the traffic signal controller 106). However, by winding the insect repelling resin product 10 about the protective member 110, the insects are prevented or repelled from penetrating the apparatus via the protective member 110.

In yet another example, FIGS. 14A and 14B illustrates the use of the insect repelling resin product 10 in an alternative embodiment. The relay box 116 of FIGS. 14A and 14B comprises a plurality of conductors such as an outside wire 120a and inside wires 120b-120d. The insect repelling resin products 10 are disposed about each of the wires 120a-120d, thus repelling insects from penetrating into the apparatus via the conducting wires 120a-120d, Accordingly, by merely winding the insect repelling resin product 10 around the outside wires (i.e., long bodies) which provide a path for insects to penetrate into the relay box 116, the penetration of the insects can be prevented prior to the insects reaching any gaps providing entrance to the relay box 116.

Referring now to FIG. 8, a perspective view of another embodiment of an insect repelling resin product 11 is shown. The insect repelling resin product 11 comprises bellows formed of convex portions 13 and concave portions 15. Further, the insect repelling resin product 11 comprises a slit 17 formed in a longitudinal direction of the insect repelling resin product 11. Moreover, the insect repelling resin product 11 is flexible, and may be expanded and deformed by pushing the slit 17 outward or inward. Thus, the insect repelling resin product 11 may be elastically fastened to a long body such as a cord, electric wire, conducting wire, cable, pipe, or any other object where a length in a longitudinal direction is generally greater than a diameter of a cross section of the object. The insect repelling resin product 11 further may bundle a plurality of long bodies. Thus in the examples of FIG. 12 through FIG. 14B, the insect repelling resin product 10 may be replaced with the insect repelling resin product 11.

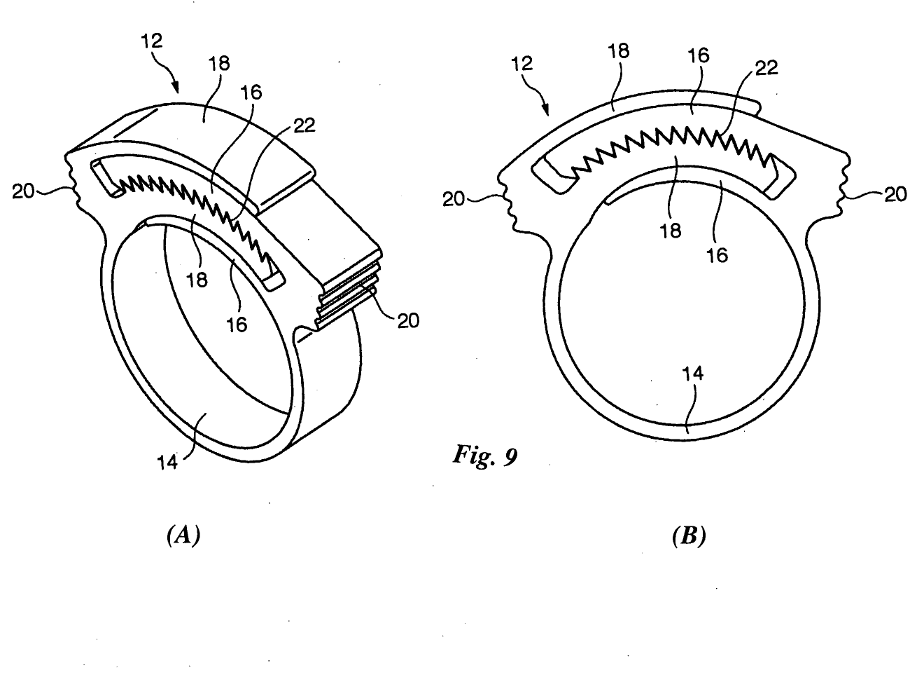

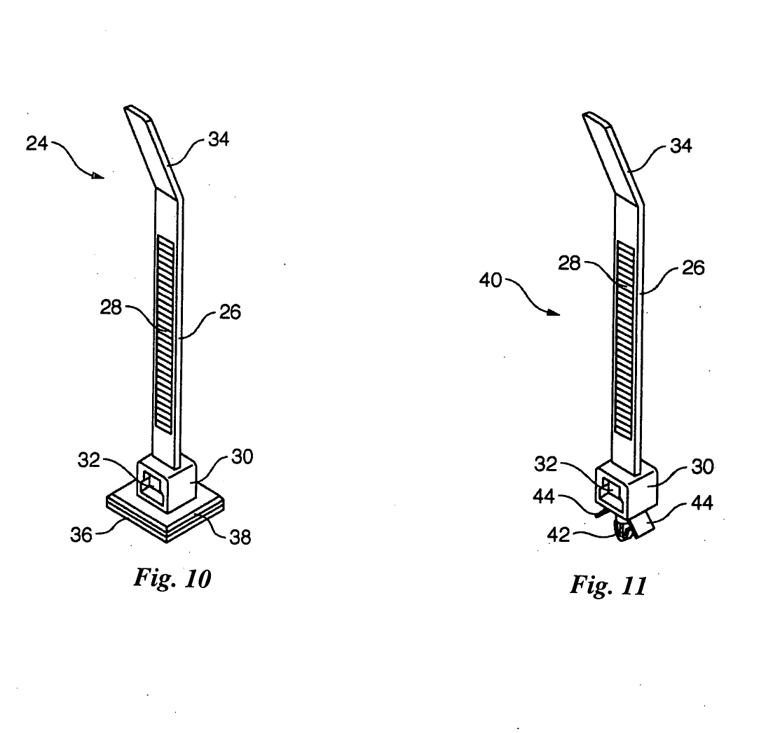

FIGS. 9A and 9B illustrate another embodiment of an insect repelling resin product 12. In this embodiment, the insect repelling resin product 12 comprises an approximate C-shaped curvature portion 14. Further, a male engagement portion 16 and a female engagement portion 18 are formed at either end of the curvature portion 14. The insect repelling resin product 12 further comprises an operation piece 20 and a locking part 22 formed on the male engagement portion 16 and the female engagement portion 18, respectively. When bundling long bodies such as wires, the wires are bundled within the insect repelling resin product 12 (i.e., within a space created by the curvature portion 14 and the male and female engagement portions 16 and 18, respectively) by applying pressure to the operation piece 20 such that the locking part 22 of the male engagement portion 16 and the locking part 22 of the female engagement portion 18 are engaged. In a further embodiment, a fastening portion (not shown) may be provided to a bottom portion of the curvature portion 14 so as to fasten the bundled long bodies to an object such as a wall. The fastening portion will be described in more detail infra (e.g., fastening portions of embodiments of FIG. 10 and FIG. 11).

FIG. 10 is another embodiment of an insect repelling resin product 24. The embodiment of FIG. 10 comprises an elastic strip 26 having a locking part 28 formed approximately in a center thereof. In an alternative embodiment, a length in a longitudinal direction and a length in a width direction of the locking part 28 may be changed as necessary. A main support 30 is coupled at a base end of the elastic strip 26. An engagement portion 32 having an engagement claw is formed in the main support 30. A plurality of wires or cables may be bundled by the insect repelling resin product 24 by inserting an operation portion 34 through the engagement portion 32 and engaging the locking part 28 against the engagement claw of the engagement portion 32. In a further embodiment, a fastening portion 38 formed at a lower part of the main support 30 and having an adhesive layer 36 may be provided. Thus, the bundled wires or cables may be fastened to an object such as a wall surface.

FIG. 11 is an alternative embodiment of an insect repelling resin product 40 similar to the embodiment of FIG. 10. However, the insect repelling resin product 40 replaces the fastening portion 38 (FIG. 10) with an elastic one-way piece 42 having an arrow shape and a bias portion 44 on either side of the elastic one-way piece 42. Thus, the insect repelling resin product 40 is fastened to a wall of an object by penetrating the wall through a hole (not shown) with the elastic one-way piece 42. Initially, the elastic one-way piece 42 is compressed to fit through the hole. Once the elastic one-way piece 42 extends beyond the hole, each side of the arrow shape will expand to its original shape, thus anchoring the insect repelling resin product 40. The bias portions 44 may then contact and press against the wall on an opposite side of the wall from where the elastic one-way piece 42 is anchored. Consequently, the insect repelling resin product 40 is stably maintained.

In alternative embodiments of the present invention, the insect repelling resin product may be formed into a thin sheet or strip. Thus, for example, the thin sheet insect repelling resin product may be coupled to an inside cover 108 or along an edge portion of the main body 114 of FIG. 13B. Further, the thin sheet insect repelling resin product may be cut to conform to components within an object. For example, a circular cutout of the thin sheet insect repelling resin product allows the resin product to be placed on a bottom of the traffic signal controller 106 of FIG. 13B so as to cover a ground surface G. As a further example, the thin sheet insect repelling resin product may be coupled to an inside door 116 of FIG. 14B, or may be formed in conformity with a shape of a main body wall 12 in contact with the door 116 when the door 116 is closed. Accordingly, the insect repelling resin product may be formed into any shape and/or size necessary or desired by a user.

In all the embodiments of the present invention, insect repelling resin product comprises at least one type of resin to structure the product. The at least one type of resin may comprise polyacetal resin, polyamide resin, acrylonitrile butadiene styrene copolymer (ABS resin), polystyrene (PS), polyethylene (PE), polypropylene (PP), polycarbonate (PC), vinyl chloride resin (PVC), polybutylene terephthalate (PBT), polyethylene terephthalate (PET), polyphenylene oxide (PPO), and thermoplastic elastomer. In some embodiments of the present invention, the various shapes of the insect repelling resin product are create via molding techniques such as, but not limited to, injection molding.

Further, it is desirable to utilize a compound having an effect of retaining the insect repelling components in the resin and adding sustained-release property thereto. Examples of such compounds having sustained-release properties comprise sulfa derivative, sulfonic ester derivative, carboxylic amide derivative, and carboxylate ester derivative. By including the sustained-release compound, the insect repelling component will be discharged from the resin over an extended period of time. In one embodiment, the insect repelling resin product is able to maintain a repelling effect for approximately ten years.

The composition of the various components (e.g., resin, insect repelling component, compound having sustained-release properties, etc.) of the insect repelling resin product varies in accordance with the selected components and the desired length of time (i.e., number of years) to maintain the insect repelling effect. According to exemplary embodiments of the present invention, the composition may comprise a mix of 100 weight parts of resin, 0.01 to 30 weight parts of the insect repelling component, and 2 to 60 weight parts of the compound having sustained-release properties. Alternative embodiments may have a different combination of the components.

The present invention further provides a method for repelling insects. An insect repelling resin product, such as those described above, is created having an insect repelling component in the resin. The insect repelling component is of a type which will be gradually discharged over time (e.g., several years). The insect repelling resin product is then disposed in an area along a path insects may travel along or penetrate an object by. Accordingly, the insect repelling resin product may be disposed in any fashion required within, around, or on the object to be protected. Because the insect repelling component is gradually discharged from the resin, the insects are prevented or repelled from penetrating the object.

In addition, the insect repelling resin product of the present invention is deformable into various shapes, and thereby can be properly applied no matter how a shape of an attachment portion changes. For example, in the field of agriculture or gardening, when the insect repelling resin product according to the embodiment of FIG. 7 is attached to a trunk of a young tree, the insect repelling resin product changes its shape so that its diameter widens according to a change of the tree's trunk diameter due to growth of the young tree, and thereby the insect repelling effect can be maintained for a long period of time.

The present invention has been described above with reference to exemplary embodiments. It will be apparent to those skilled in the art that various modifications may be made and other embodiments can be used without departing from the broader scope of the present invention. For example, the present invention may comprise other similar shapes as those described infra. Therefore, these and other variations upon the exemplary embodiments are intended to be covered by the present invention.

What is claimed is:

1. An insect repelling resin product to be employed in an object, comprising
a resin;
an insect repelling component contained in the resin, the insect repelling component being gradually discharged from the resin over time; and
a geometric feature applicable to a path along which insects travel.

2. The insect repelling resin product of claim 1 wherein the geometric feature is a main body configured for insertion into an aperture of the object.

3. The insect repelling resin product of claim 2 further comprising a fastening means coupled to an outer peripheral face of the main body.

4. The insect repelling resin product of claim 2 further comprising a flange coupled along one end of the main body.

5. The insect repelling resin product of claim 2 wherein the main body comprises a hollow center.

6. The insect repelling resin product of claim 1 wherein the insect repelling resin product is configured to be elastically deformable in conformity with employment in the object.

7. The insect repelling resin product of claim 1 wherein the geometric feature is an elongated U-shaped body having an opening end portion forming a groove, the opening end portion configured for providing an ability to employ the insect repelling resin product along a protruding edge portion of the object.

8. The insect repelling resin product of claim 7 further comprising a plurality of slits, the slits configured for providing an ability to employ the insect repelling resin product along curvatures.

9. The insect repelling resin product of claim 1 wherein the geometric feature is a spiral shape, the spiral shape configured for providing an ability to employ the insect repelling resin product about at least one long body.

10. The insect repelling resin product of claim 1 wherein the geometric feature is a tube shape having a slit in a longitudinal direction, the tube shape being deformable along the slit to employ the insect repelling resin product about at least one long body.

11. The insect repelling resin product of claim 1 wherein the geometric feature is a C-shaped curvature portion coupled to a male and female engagement portion.

12. The insect repelling resin product of claim 1 wherein the geometric feature is an elastic strip further comprising a locking portion and an engagement portion.

13. The insect repelling resin product of claim 1 further comprising a fastening means.

14. The insect repelling resin product of claim 13 wherein the fastening means is a elastic one-way piece.

15. The insect repelling resin product of claim 1 wherein the insect repelling component further comprises a compound providing sustained-release property to the insect repelling component.

16. The insect repelling resin product of claim 1 wherein the geometric feature is a flat sheet, the flat sheet being customizable.

17. A method for utilizing an insect repelling resin product, comprising:
disposing a molded insect repelling resin product having an insect repelling component to an area along a path in which insects travel in order to penetrate an object; and
gradually discharging the insect repelling component to deter the insects from penetrating the object.

18. The method of claim 17 wherein the disposing further comprises installing the molded insect repelling resin product in an aperture formed in the area.

19. The method of claim 17 wherein the disposing further comprises installing the molded insect repelling resin product along an edge portion.

20. The method of claim 17 wherein the disposing further comprises disposing the molded insect repelling resin product in a gap formed in the area.

21. The method of claim 17 wherein the disposing further comprises disposing the molded insect repelling resin product about at least one long body.

22. A method for producing an insect repelling resin product, comprising:
providing at least a resin, an insect repelling component, and a compound having sustained-release properties, the compound having sustained-release properties causing the insect repelling component to be gradually discharged;
combining at least the resin, the insect repelling component, and the compound having sustained-release properties; and
molding at least the resin, the insect repelling component, and the compound having sustained-release property into geometric feature applicable to a path along which insects travel.

23. The method of claim 22 wherein the geometric feature is a main body shaped for insertion into an aperture of the object.

24. The method of claim 23 wherein the main body comprises a hollow center.

25. The method of claim 22 wherein the geometric feature is an elongated U-shaped body having an opening end portion forming a groove, the opening end portion configured for providing an ability to employ the insect repelling resin product along a protruding edge portion of the object.

26. The method of claim 25 further comprising a plurality of slits, the slits configured for providing an ability to employ the insect repelling resin product along curvatures.

27. The method of claim 22 wherein the geometric feature is a spiral shape, the spiral shape configured for providing an ability to employ the insect repelling resin product about at least one long body.

28. The method of claim 22 wherein the geometric feature is a tube shape having a slit in a longitudinal direction, the tube shape being deformable along the slit to employ the insect repelling resin product about at least one long body.

29. The method of claim 22 wherein the geometric feature is a C-shaped curvature portion coupled to a male and female engagement portion.

30. The method of claim 22 wherein the geometric feature is an elastic strip further comprising locking portion and an engagement portion.

31 The method of claim 22 wherein the geometric feature is a flat sheet, the flat sheet being customizable.

32. A system for utilizing an insect repelling resin product, comprising
means for disposing a molded insect repelling resin product having an insect repelling component to an area along a path in which insects travel in order to penetrate an object; and
means for gradually discharging the insect repelling component to deter the insects from penetrating the object.
